(19) United States
(12) Patent Application Publication
(10) Pub. No.: US 2025/0028989 A1
(43) Pub. Date: Jan. 23, 2025

(54) METAL TRITIDES AS BETA SOURCES FOR TRUE RANDOM NUMBER GENERATORS

(71) Applicant: mb-microtec ag, Niederwangen (CH)

(72) Inventors: Serge Lukas ZIHLMANN, Gasel (CH); Samuel Lukas EGLI, Basel (CH); Johannes Peter KIND, Bern (CH)

(21) Appl. No.: 18/353,695

(22) Filed: Jul. 17, 2023

(51) Int. Cl. G06N 10/40

(52) U.S. Cl. CPC G06N 10/40

(57) ABSTRACT

A system includes a random signal generator and a processor. The random signal generator generates detection signals of radioactive decay events. The random signal generator includes a detector and a metal tritide device disposed at the detector. The detector generates the detection signals based on detection of beta particles from radioactive decay of tritium. The detection signals include randomized timing information of the radioactive decay events. The metal tritide device includes the tritium. The tritium in the metal tritide device undergoes radioactive decay to emit the beta particles. The processor generates a random value based on the detection signals of the radioactive decay events.

### BACKGROUND

### Field

The present disclosure relates to the manufacture and use of a metal tritide device, for example, a safe and stable metal tritide device for use in random number generator applications.

### Background

A random number generator (RNG) is an essential part of many widely used software implementations, such as encryption, simulations, video games, slots, to name a few. Software algorithms for randomization are generally considered pseudo random from the perspective that such algorithms rely on a seed value and, if a seed value is repeatable, then the output of the algorithm is predictable and no longer random. Furthermore, pseudo RNGs can be a weakness in cryptography in that pseudo random numbers can have patterns that can be analyzed for next value prediction. On the other hand, a true random number generator (TRNG) is capable of true randomization. A quantum RNG is an example of a TRNG, which relies on quantum processes (probabilistic) and are truly random. RNGs that rely on radioisotope decay are an example of a quantum RNG. While radioisotope-based RNGs offer appealing functionality in terms of randomization, practical implementation is challenging due to safety issues and difficulty of fabricating a compact randomizer device comparable in size to modern-day electronic components.

### SUMMARY

Accordingly, there is a need in TRNG technologies for low cost, mass producible TRNGs that are relatively small, safe to fabricate and safe to use.

In some aspects, a system can comprise a random signal and a processor. The random signal generator can generate detection signals of radioactive decay events. The random signal generator can comprise a detector and a metal tritide device. The detector can generate the detection signals based on detection of beta particles from radioactive decay of tritium. The detection signals can comprise timing information of the radioactive decay events. The metal tritide device can be disposed at the detector. The metal tritide device can comprise the tritium. The metal tritide device can undergo random radioactive decay to emit the beta particles. The processor can generate a random value based on the detection signals of the radioactive decay events.

In some aspects, a random signal generator can comprise a detector and a metal tritide device. The detector can generate detection signals of radioactive decay events based on detection of beta particles from radioactive decay of tritium. The detection signals can comprise randomized timing information of the radioactive decay events. The metal tritide device can be disposed at the detector. The metal tritide device can comprise the tritium. The metal tritide device can undergo random radioactive decay to emit the beta particles.

In some aspects, a method of fabricating a random signal generator can comprise disposing a tritide-forming metal layer on a substrate. The method can also comprise disposing the substrate with the tritide-forming metal in a vacuum chamber. The method can also comprise exposing the tritide-forming metal at a given temperature to tritium gas for a given exposure time to form metal tritide having a thickness that is based on the given temperature and the given exposure time. The substrate can be part of a detector or the method can also comprise disposing the metal tritide on a detector.

Further features of various aspects of the present disclosure are described in detail below with reference to the accompanying drawings. It is noted that the present disclosure is not limited to the specific aspects described herein. Such aspects are presented herein for illustrative purposes only. Additional aspects will be apparent to those skilled in the relevant art(s) based on the teachings contained herein.

### BRIEF DESCRIPTION OF THE DRAWINGS/FIGURES

The accompanying drawings, which are incorporated herein and form part of the specification, illustrate the present disclosure and, together with the description, further serve to explain the principles of the present disclosure and to enable those skilled in the relevant art(s) to make and use aspects described herein.

FIG. 1 shows a system that implements a random signal generator, according to some aspects.

FIGS. 2-7 shows portions of random signal generators, according to some aspects.

FIG. 8 shows a metal tritide device, according to some aspects.

FIG. 9 shows a plot graph of a timing scheme of detection signals, according to some aspects.

FIG. 10 shows a flowchart of a method of making a metal tritide device, according to some aspects.

FIG. 11 shows a computer system for implementing random number generation functions, according to some aspects.

The features of the present disclosure will become more apparent from the detailed description set forth below when taken in conjunction with the drawings, in which like reference characters identify corresponding elements throughout. In the drawings, like reference numbers generally indicate identical, functionally similar, and/or structurally similar elements. Additionally, generally, the left-most digit(s) of a reference number identifies the drawing in which the reference number first appears. Unless otherwise indicated, the drawings provided throughout the disclosure should not be interpreted as to-scale drawings.

### DETAILED DESCRIPTION

The aspects described herein, and references in the specification to “one aspect,” “an aspect,” “an exemplary aspect,” “an example aspect,” etc., indicate that the aspects described can include a particular feature, structure, or characteristic, but every aspect may not necessarily include the particular feature, structure, or characteristic. Moreover, such phrases are not necessarily referring to the same aspect. Further, when a particular feature, structure, or characteristic is described in connection with an aspect, it is understood that it is within the knowledge of those skilled in the art to effect such feature, structure, or characteristic in connection with other aspects whether or not explicitly described.

Spatially relative terms, such as “beneath,” “below,” “lower,” “above,” “on,” “upper” and the like, can be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus can be otherwise oriented (rotated 90 degrees or at other orientations) and the spatially relative descriptors used herein can likewise be interpreted accordingly.

The terms “about,” “approximately,” or the like can be used herein to indicate the value of a given quantity that can vary based on a particular technology. Based on the particular technology, the terms “about,” “approximately,” or the like can indicate a value of a given quantity that varies within, for example, 10-30% of the value (e.g., +10%, ±20%, or ±30% of the value).

Aspects of the present disclosure can be implemented in hardware, firmware, software, or any combination thereof. Aspects of the disclosure can also be implemented as instructions stored on a computer-readable medium, which can be read and executed by one or more processors. A machine-readable medium can include any mechanism for storing or transmitting information in a form readable by a machine (e.g., a computing device). For example, a machine-readable medium can include read only memory (ROM); random access memory (RAM); magnetic disk storage media; optical storage media; flash memory devices; electrical, optical, acoustical or other forms of propagated signals (e.g., carrier waves, infrared signals, digital signals, etc.), and others. Furthermore, firmware, software, routines, and/or instructions can be described herein as performing certain actions. However, it should be appreciated that such descriptions are merely for convenience and that such actions result from computing devices, processors, controllers, or other devices executing the firmware, software, routines, instructions, etc. The term “machine-readable medium” can be interchangeable with similar terms, for example, “computer program product,” “computer-readable medium,” “non-transitory computer-readable medium,” or the like. The term “non-transitory” can be used herein to characterize one or more forms of computer readable media except for a transitory, propagating signal.

Safety is an important consideration when manufacturing and using devices containing radioisotopes. Radioisotopes can pose a severe health risk to exposed persons during fabrication or consumer use. Radioisotopes such as cobalt-60, strontium-90, cesium-137, americium-241, nickel-63, and tritium (hydrogen-3) have been considered for use in quantum RNGs. For example, a tritium random number generator with a cavity filled with gaseous tritium is disclosed in U.S. Pat. No. 10,430,161, issued on Oct. 1, 2019, the contents of which is incorporated by reference herein in its entirety. The fabrication process for containment units of gaseous tritium, or any radioactive material, can be complex and precise with little margin for error. For example, while tritium gas cavities can be conceptualized as in U.S. Pat. No. 10,430,161, practical implementations typically address problems of hermeticity of the gas container and the low power density of beta particle emissions due to low density of atoms and/or molecules in gases, even more so if the cavity is filled with a low pressure gas.

In some aspects, using tritiated liquids can provide a solution to the power density issue, but hermeticity and leak proofing are still a concern. A mechanical failure of a device with liquid can result in radioactive contamination to the surrounding environment. Furthermore, depending on the chemical nature of the liquid, aging due to radiolysis can be a significant problem. As will be discussed further below, there are numerous metal tritides that are stable at ambient conditions, making for excellent tritium containment and preservation.

Furthermore, as radioisotopes can have different matter states (e.g., gas or solid) and can produce different types of radiation, choosing a suitable radioisotope for electronics implementation can be difficult. One radioisotope may not be easily substituted by another. For example, americium-241 generates alpha particle. In contrast, cobalt-60, strontium-90, cesium-137, nickel-63, and tritium generate beta particles. Alpha particles are, owing to their higher mass and kinetic energy, capable of degrading nearby structures at a molecular and atomic level. In other words, a detector in the vicinity of an alpha particle emitter can degrade to the point that the detector has usable life span of, for example, 2 years or less, 1 year or less, or the like. Device lifetime on this scale can be unsuitable for RNG implementation. Some radioisotopes can decay into a more harmful radioisotope (e.g., cesium-137 can decay into barium-137, which produces gamma radiation). Some radioisotopes can form stable bonds with a host material while others can be prone to outgassing.

Disclosed herein are aspects of devices and fabrication process flows that allow for safe, mass-producible, low cost manufacture of durable tritium-based RNG devices that are safe and reliable for consumer use.

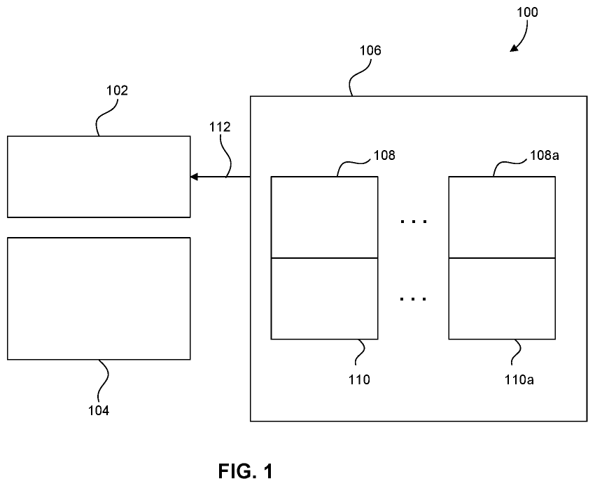

FIG. 1 shows a system 100 that implements a random signal generator 106, according to some aspects. In some aspects, system 100 can include a processor 102, a memory 104, and a random signal generator 106. Random signal generator 106 can include a detector 108 and a metal tritide device 110. Metal tritide device 110 includes tritium (e.g., tritiated metal) and is disposed at detector 108. Detector 108 can generate detection signals 112 of radioactive decay events based on detection of beta particles from random radioactive decay of the tritium. Detection signals 112 can include randomized timing information of the radioactive decay events.

In some aspects, a detector device capable of converting the radiation from tritium-decay into detection signals 112 can be used as detector 108. Such detectors can include, for example, avalanche photodiodes, PIN diodes, charge coupled devices (CCD), complementary metal-oxide semiconductor (CMOS) detectors, metal-oxide-semiconductor field-effect transistor (MOSFET) detectors, or the like. Furthermore, the types of detectors are not limited to those that directly capture beta particles from radioactive decay. That is, detection of radiation can be direct (e.g., direct absorption of beta particles by the detector) or indirect (e.g., beta particles are absorbed by an intermediary device/material that radiates a secondary radiation, such as photons, and the secondary radiation is detected). And, while it is not shown FIG. 1, it is to be appreciated that detector 108 can include additional circuits that can aid in successful detection of received particles. Such circuits can include, for example, amplifiers, signal filters, buffers, and the like.

In some aspects, memory 104 can include a non-transitory computer-readable medium for storing instructions. The instructions, when executed by processor 102, can cause the processor to perform operations. The operations can include generating a random value based on the detection signals of the radioactive decay events. The random value relies on the randomized timing information communicated by detection signals 112.

Metal tritide devices can be fabricated in compact form and en masse, according to aspects disclosed herein. And small detectors are available in compact, on-chip form. Therefore, in some aspects, it is envisaged that random signal generator 106 can include one or more additional detectors 108a and one or more metal tritide devices 110a to increase the speed at which random timing information is generated (e.g., additional detection signals). A first random signal generator unit can include detector 108 and metal tritide device 110. A second random signal generator unit can include one of one or more additional detectors 108a and one of one or more metal tritide devices 110a. The relationship can be extrapolated to a third random signal generator unit, a fourth random signal generator unit, and so on.

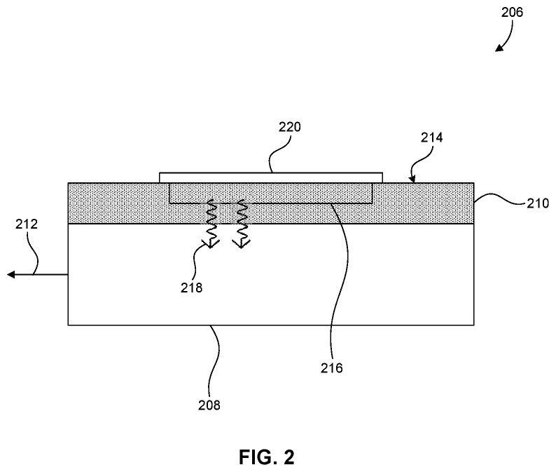

FIG. 2 shows a portion of a random signal generator 206, according to some aspects. In some aspects, random signal generator 206 can be used in system 100 of FIG. 1. Structures and functions of matching numbered elements in FIGS. 1 and 2 can be as described above, unless otherwise noted. Matching elements can have reference numbers that share the two right-most numeric digits. Such elements can include random signal generator 206, detector 208, metal tritide device 210, and/or detection signals 212.

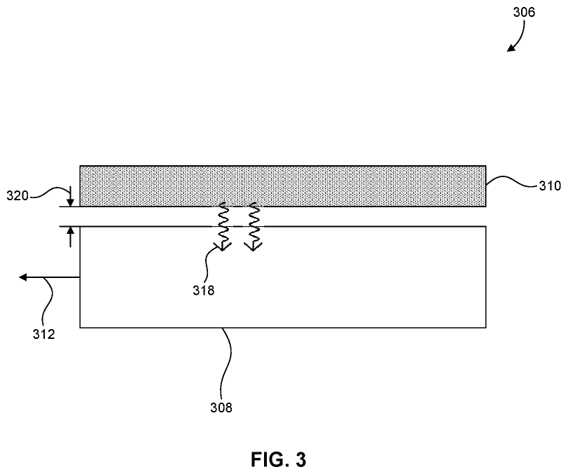

In some aspects, metal tritide device 210 includes tritiated metal (e.g., metal material infused with atomic tritium). Metal tritide device 210 can be a film of the metal tritide material. In some aspects, the metal tritide material can be delimited to a more localized region, for example, as illustrated for metal tritide film 216. The film thickness can be about 0.05 to 2.0 microns, 0.5 to 1.5 microns, 1.0 to 1.5 microns, 0.5 microns, 1.0 micron, 1.5 microns, or the like. Metal tritide device 210 can include a substrate 214. Substrate 214 can be a rigid wafer or a metal foil. In some aspects, substrate 214 can be an integral part of detector 208 (e.g., detector 208 can have a surface on which metal tritide film 216 is deposited; a substrate can be a material that provides the surface on which something is deposited, inscribed, or otherwise disposed upon or within). In some aspects, substrate 214 can initially be a separate article from detector 208, with metal tritide being deposited on the separate article, and then later assembled with detector 208. In some aspects, metal tritide device 210 on substrate 214 can be flipped and bonded to detector 208 (e.g., flip-chip bonding), and substrate 214 can then optionally be removed (e.g., polished off). Metal tritide device 210 can be in contact with detector 208. Alternatively, as will be discussed below in reference to FIG. 3, metal tritide device 210 can be disposed such that there is a gap between metal tritide device 210 and detector 208.

In some aspects, metal tritide device 210 can solve the problems discussed above regarding gaseous tritium. Containment of tritium gas can depend, for example, on quality of hermeticity. A tritium gas cavity can leak if the cavity has a faulty or poorly fabricated seal, is degraded over time, and/or is broken due to shock. On the other hand, metal tritide is capable of retaining tritium atoms via chemical bonding (e.g., by forming a metal tritide molecule). There are numerous metal types capable of forming a long-lasting, stable bond with tritium, for example, scandium, titanium, magnesium, palladium, lithium, beryllium, yttrium, or the like-any of which can be used as a host metal in metal tritide device 210 (e.g., scandium is a metal that can be used as foil material for substrate 214). Terms such as “tritiation” and “tritiated” can be used to refer to a process of exposing a material to tritium molecules (e.g., as gas) to form tritide molecules (e.g., tritiation of a metal, tritiated water, or the like).

In some aspects, when tritium is bonded to a metal, the metal can provide a stable, solid host for tritium (e.g., at room temperature) that does not flow as gases or liquids do. Hence, tritium leakage (e.g., when in gas or liquid form) can be mitigated via metal tritide implementation even in the absence of a hermetic environment. Furthermore, the metal tritide can be stable (e.g., resistant to outgassing) at room temperatures (e.g., about 22 degrees Celsius), as well as at temperatures of common computer components (e.g., about 40 to 125 degrees Celsius). Certain metals, such as scandium, can form a tritide (e.g., scandium tritide) that is stable to even higher temperatures, for example, about 200 degrees Celsius or greater. Such metals are desirable for when metal tritide device 210 is subjected to, or is within proximity of, high heat processes (e.g., soldering).

It was mentioned earlier that, in some aspects, metal tritide device 210 can have the form of a film with a given thickness (e.g., about 0.05 to 2.0 microns, 0.5 to 1.5 microns, 1.0 to 1.5 microns, 0.5 microns, 1.0 micron, 1.5 microns). The structure of metal tritide film 216 can provide some desirable features and/or mitigate some drawbacks. The tritium in metal tritide device 210 can be a radioactive source of beta particles 218 (beta particles are relied upon for the random signal generation described in reference to FIG. 1). Beta particles 218 can be easily blocked by matter. In another example, a bulk block of metal tritide is capable of self-blocking beta particles generated deep from within the block. Expressed differently, beta particles from tritium can have an average travel distance of approximately 1.0 to 1.5 microns before they are absorbed by the metal tritide block, thereby causing a reduction of kinetic energy or causing some of the beta particles to be unable to leave the block. Therefore, increasing thicknesses of metal tritide blocks can be accompanied by a saturation of beta particle emissions (e.g., increasing the thickness of the metal tritide block is not accompanied by an increase of the number of emitted beta particles per unit surface). By implementing a thin metal tritide film 216, the volume budget of metal tritide device 210 (and by extension, the volume of random signal generator 106) can be minimized. Volume minimization aligns with market demands in electronics regarding smaller and more efficient devices.

In some aspects, a protective coating 220 can be disposed on metal tritide film 216. Described differently, metal tritide film 216 can be disposed between detector 208 and protective coating 220 (e.g., fully enclosed). This arrangement can mitigate trace release of tritium due to an additional diffusion barrier, suppress oxidation of the metal (which can promote release of tritium), and prevent direct contact with metal tritide film 216 as the structure is handled during use or assembly.

In some aspects, random signal generator 206 can be disposed on a support structure (e.g., substrate, printed circuit board (PCB), fabricated on the same die as processor 102, or the like).

FIG. 3 shows a portion of a random signal generator 306, according to some aspects. In some aspects, random signal generator 306 can be used in system 100 of FIG. 1. Structures and functions of matching numbered elements in FIGS. 1-3 can be as described above, unless otherwise noted. Matching elements can have reference numbers that share the two right-most numeric digits. Such elements can include random signal generator 306, detector 308, metal tritide device 310, detection signals 312, and/or beta particles 318.

In some aspects, metal tritide device 310 can be a film of metal tritide. Detector 308 and metal tritide device 310 can be separate at least in part by a gap 320. Gap 320 can be a design parameter (e.g., in certain applications where gap 320 can be of utility, for example, being filled with scintillating material). In some aspects, gap 320 can result from imperfections at the interface between detector 308 and metal tritide device 310 (e.g., intended to be in contact, but microscopic imperfections cause microscopic air gaps).

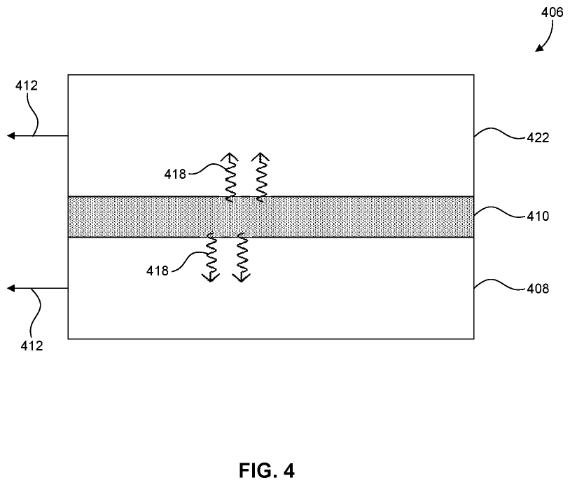

FIG. 4 shows a portion of a random signal generator 406, according to some aspects. In some aspects, random signal generator 406 can be used in system 100 of FIG. 1. Structures and functions of matching numbered elements in FIGS. 1-4 can be as described above, unless otherwise noted. Matching elements can have reference numbers that share the two right-most numeric digits. Such elements can include random signal generator 406, detector 408, metal tritide device 410, detection signals 412, and/or beta particles 418.

In some aspects, random signal generator 406 can further include a detector 422 (e.g., an additional detector). Detector 408 can be disposed at one side (e.g., a first side) of metal tritide device 410 while detector 422 can be disposed at an opposite side (e.g., a second side) of metal tritide device 410. In this manner, metal tritide device 410 can be enclosed (e.g., protected, similar to the function of coating 220 in FIG. 2). Either of, or both, detectors 408 and 422 can be in contact with metal tritide device 410. Furthermore, the radiation of beta particles 418 can be isotropic. Hence, instead of “wasting” the beta particles that travel away from detector 408 (e.g., additional beta particles), such beta particles can be detected by detector 422. Using both detectors 408 and 422 can increase the efficiency and performance of random signal generator 406. Using both detectors 408 and 422 can increase the frequency of the generating of detection signals 412 (e.g., by generating additional detection signals).

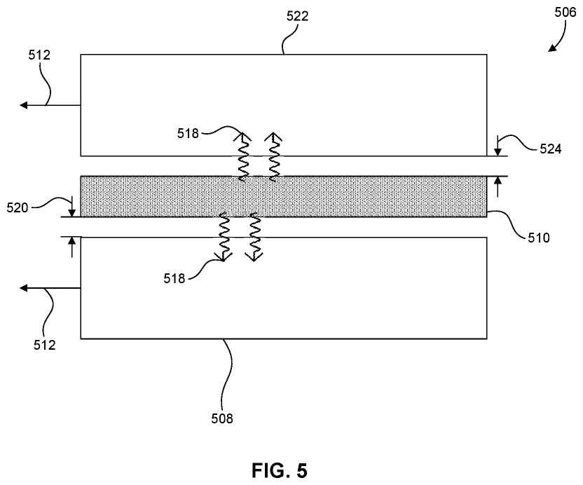

FIG. 5 shows a portion of a random signal generator 506, according to some aspects. In some aspects, random signal generator 506 can be used in system 100 of FIG. 1. Structures and functions of matching numbered elements in FIGS. 1-5 can be as described above, unless otherwise noted. Matching elements can have reference numbers that share the two right-most numeric digits. Such elements can include random signal generator 506, detector 508, metal tritide device 510, detection signals 512, beta particles 518, gap 520, and/or detector 522.

In some aspects, metal tritide device 510 can be a film of metal tritide. Gap 520 can be present between detector 508 and metal tritide device 510. A gap 524 can be present between detector 522 and metal tritide device 510. Detector 508 can be disposed at one side (e.g., a first side) of metal tritide device 510 while detector 522 can be disposed at an opposite side (e.g., a second side) of metal tritide device 510. Gap 520 can be a design parameter (e.g., in certain applications where gap 520 can be of utility). In some aspects, gap 520 can result from imperfections at the interface between detector 508 and metal tritide device 510 (e.g., intended to be in contact, but microscopic imperfections cause microscopic air gaps). The relationship between gap 524, detector 522, and metal tritide device 510 is as described above for the relationship between gap 520, detector 508, and metal tritide device 510. Two-sided capture of beta particles 518 can result in a more efficient and higher performance device.

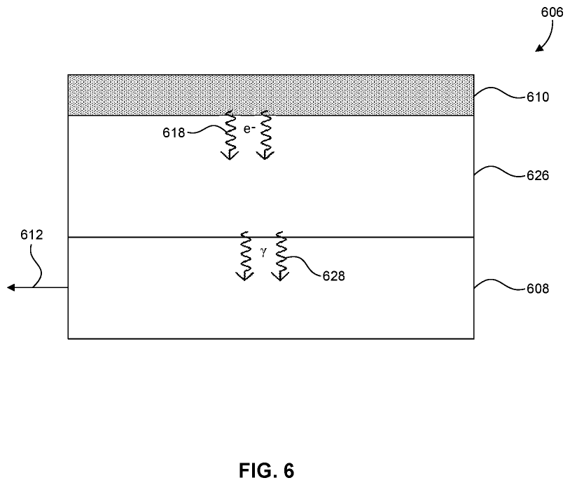

FIG. 6 shows a portion of a random signal generator 606, according to some aspects. In some aspects, random signal generator 606 can be used in system 100 of FIG. 1. Structures and functions of matching numbered elements in FIGS. 1-6 can be as described above, unless otherwise noted. Matching elements can have reference numbers that share the two right-most numeric digits. Such elements can include random signal generator 606, detector 608, metal tritide device 610, detection signals 612, and/or beta particles 618.

In some aspects, random signal generator 606 can further include a scintillator 626. Scintillator 626 can be disposed between detector 608 and metal tritide device 610. Scintillator 626 can convert beta particles 618 (e⁻) to photons 628 (γ). Described differently, scintillator 626 can receive beta particles 618 from the metal tritide device 610 and convert at least a portion of beta particles 618 to photons 628. A single beta particle can generate many photons (or one or more photons). Detector 608 can be configured (or otherwise designed) to be sensitive to photons (as opposed to beta particles). Detector 608 can receive photons 628 to generate detection signals 612 with randomized timing information owing to the random nature of the radioactive decay. In this manner, the decay events producing beta particles from metal tritide device 608 can be indirectly detected via detection of photons. Any suitable scintillating material can be used for the construction of scintillator 626 (e.g., zinc sulfide). Additional examples of scintillators for RNG applications can be found in U.S. Pat. No. 11,614,921, issued on Mar. 28, 2023, and U.S. Pub. Appl. No. 2021/0247965, published on Aug. 12, 2021, the contents of which are incorporated by reference herein in their entirety.

In some aspects, scintillator 626 can be one of two scintillators, with the second scintillator being disposed on an opposite side of metal tritide device 610. Such an arrangement can be used with the detection arrangement shown in FIG. 5. The scintillators can fill the space of gaps 520 and 524 (FIG. 5).

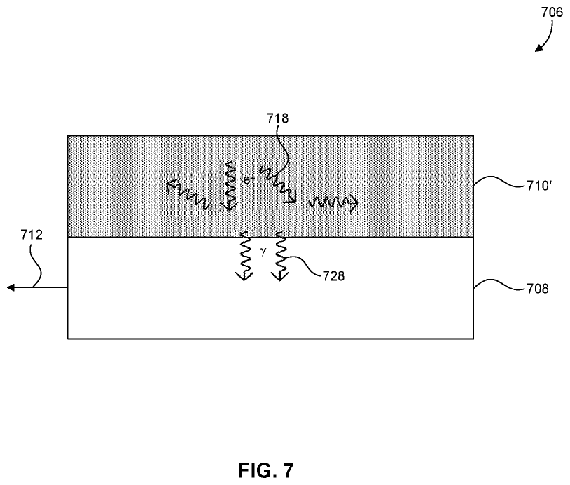

FIG. 7 shows a portion of a random signal generator 706, according to some aspects. In some aspects, random signal generator 706 can be used in system 100 of FIG. 1. Structures and functions of matching numbered elements in FIGS. 1-7 can be as described above, unless otherwise noted. Matching elements can have reference numbers that share the two right-most numeric digits. Such elements can include random signal generator 706, detector 708, detection signals 712, beta particles 718, and/or photons 728.

In some aspects, random signal generator 706 can include a tritiated scintillator 710′ (e.g., a metal tritide material mixed with scintillator material that combines the functions of a metal tritide device and a scintillator). The tritium in tritiated scintillator 710′ can undergo random radioactive decay to produce beta particles 718. The scintillating material in tritiated scintillator 710′ can absorb at least a portion of beta particles 718 (e.g., self-absorption), to generate photons 728. Detector 708 can receive photons 728 to generate detection signals 712 with randomized timing information owing to the random nature of the radioactive decay. Though not shown in FIG. 7, it is to be understood that an additional detector can be implemented in an arrangement that is analogous to the arrangement of FIG. 4 in order to increase efficiency and performance of random signal generator 706.

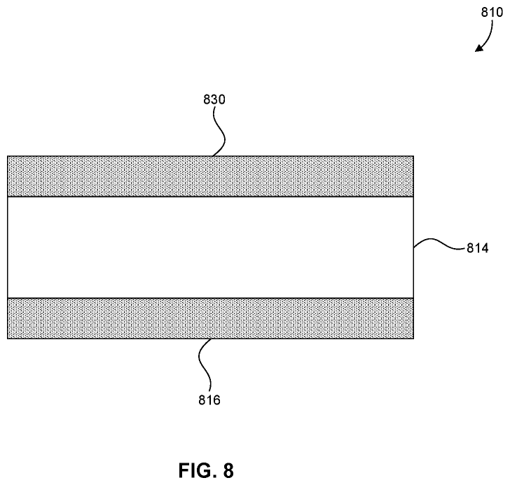

FIG. 8 shows a metal tritide device 810, according to some aspects. In some aspects, metal tritide device 810 can be used in random signal generators 106, 206, 306, 406, 506, and 606 (FIGS. 1-6). Structures and functions of matching numbered elements in FIGS. 1-7 can be as described above or below, unless otherwise noted. Matching elements can have reference numbers that share the two right-most numeric digits. Such elements can include metal tritide device 810, substrate 814, and/or metal tritide film 816.

In some aspects, metal tritide device 810 can further include a metal tritide film 830 (e.g., additional metal tritide film). Metal tritide film 816 can be disposed at one side (e.g., a first side) of substrate 814 while metal tritide film 830 can be disposed at an opposite side (e.g., a second side) of substrate 814. Substrate 814 can be a rigid wafer or a metal foil (e.g., scandium, titanium, magnesium, palladium, lithium, beryllium, yttrium, or the like). Fabrication of two-sided metal tritide devices can result in more efficient use of expensive metals (e.g., palladium) by allowing the metal tritide film to be fabricated on two sides of substrate 814 as opposed to one side.

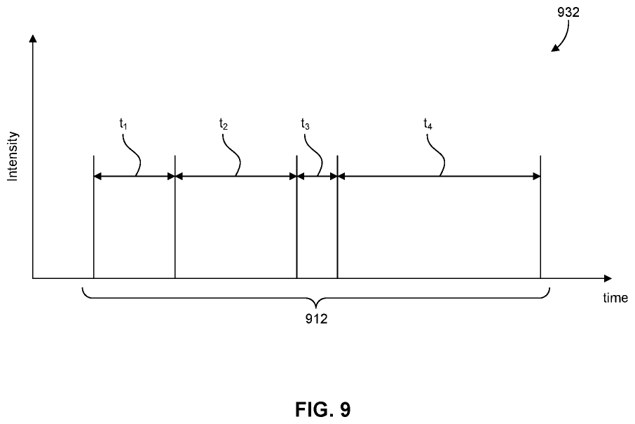

FIG. 9 shows a plot graph 932 for detection signals 912, according to some aspects. In some aspects, the features of detection signals 912 as described below can apply to detection signals 112, 212, 312, 412, 512, 612, and 712 (FIGS. 1-7).

In some aspects, the vertical axis of plot graph 932 represents an intensity of detection signals 912 and the horizontal axis represents time. Each random decay event in a metal tritide device can generate a detection signal. As random decay events occur in a metal tritide device, detection signals 912 can have a time separation as shown in plot graph 932, represented by example time periods t₁, t₂, t₃, and t₄. A desirable quality of the detection scheme is the improbability of a repeated pattern of time periods emerging. The randomized timing information conveyed by the time periods between detection signals can be converted into a number value and/or used as a seed for a RNG algorithm. The seed number value can be a random number value according to the random decay events.

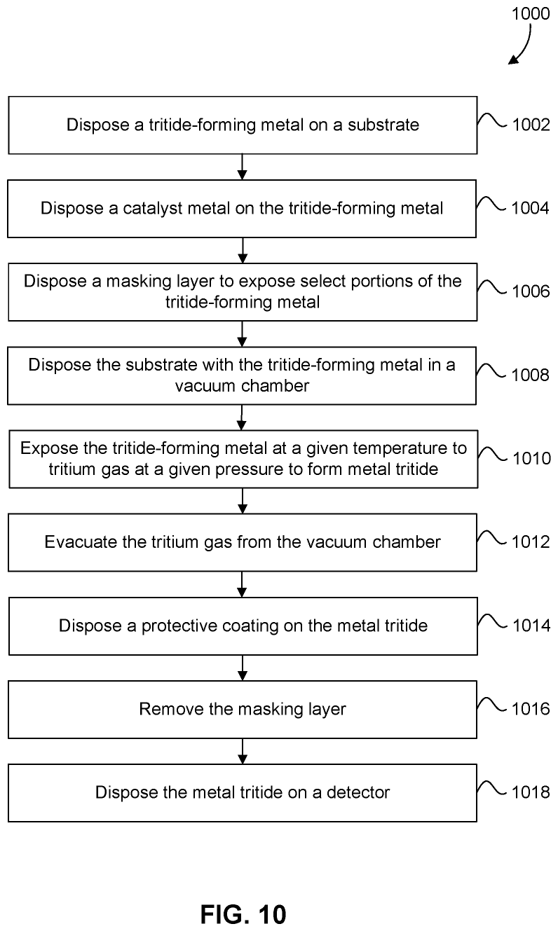

FIG. 10 shows a method 1000 for fabricating a stable metal tritide device (e.g., for use in integrated electronics), according to some aspects. In some aspects, at operation 1002, a tritide-forming metal can be disposed on a substrate. The substrate can be a wafer. The tritide-forming metal can have the property of being able to form a stable chemically bond with tritium (e.g., scandium, titanium, magnesium, palladium, lithium, beryllium, yttrium, or the like). The disposing of the tritide-forming metal on the substrate can be achieved using a suitable fabrication technique (e.g., evaporation, physical vapor deposition (PVD), sputtering, electroplating, or the like). The thickness of the tritide-forming metal can be adjusted at this step.

It is desirable to optimize a thickness of the tritide-forming metal so as to increase the number of electrons emitted through the surface of a metal tritide device (e.g., electron flux in a direction toward a detector(s)). It is desirable to maximize the electron flux while minimizing overall tritium activity (e.g., activity can be expressed in Bq or other units). Self-absorption of beta particles in the metal is undesirable because, even if a device has a high tritium activity, the released beta particles are useless if the beta particles are absorbed before reaching a detector. In some aspects, the thickness of the tritide-forming metal layer can be, for example, about 0.05 to 2.0 microns, 0.5 to 1.5 microns, 1.0 to 1.5 microns, 0.5 microns, 1.0 micron, 1.5 microns, or the like. In some aspects, the tritide-forming metal can be disposed on two sides of the substrate (e.g., for a double-sided metal tritide device as in FIG. 8).

In some aspects, deposition of the tritide-forming metal can be controlled by conditioning the deposition environment. For example, deposition of the tritide-forming metal can take place in a vacuum chamber. The pressure in the vacuum chamber can be set for optimal deposition of the tritide-forming metal using a non-reactive gas or inert gas (e.g., argon). The pressure in the vacuum chamber, during deposition, can be in the range of about 10E-6 to 10E-1 mbar. The conditions in the vacuum chamber can help prevent the sputtered or evaporated metal from undesirably interacting with other molecules like oxygen.

In some aspects, the substrate on which tritide-forming metal is disposed on can be a detector (e.g., in-situ tritiation of random signal generator). In some aspects, the substrate can be a substantially rigid support structure (e.g., a wafer). In some aspects, the substrate can be a foil. Before deposition of the tritide-forming metal, the substrate can be cleaned and/or cut (e.g., cutting the foil to workpiece sizes).

In some aspects, the depositing of the tritide-forming metal can include depositing a combination of the tritide-forming metal and a scintillating material.

In some aspects, at operation 1004, a catalyst metal can be disposed on the tritide-forming metal. Examples of catalyst metals can include a thin layer of palladium, platinum, rhodium, ruthenium, nickel, or the like. The catalyst metal can facilitate the process of dissociation of the tritium molecules at the surface and the following diffusion of the tritium atoms into the tritide-forming metal. If a noble catalyst metal is used (e.g., a metal that resists oxidation), this can be useful for preventing further oxidation of the tritide forming metal. The disposing of the catalyst metal on the tritide-forming metal can be achieved using a suitable fabrication technique (e.g., physical vapor deposition (PVD), sputtering, electroplating, or the like). The thickness of the catalyst metal layer can be much less than the thickness of the tritide-forming metal layer (e.g., about 20% or less, 15% or less, 10% or less, 5% or less, or the like). In some aspects, operation 1004 can be performed prior to operation 1010, 1008, or 1006.

In some aspects, at operation 1006, a masking layer can be disposed on the substrate to expose select portions of the tritide-forming metal. It is to be appreciated that the disposing of the masking layer on the tritide-forming metal can also include disposing the masking layer on the catalyst metal (if the catalyst metal is present). Depending on the chosen tritide-forming metal, a catalyst metal may or may not be needed. The disposing of the masking layer on the tritide-forming metal can be achieved using a suitable fabrication technique (e.g., spin-coating and lithography). In the lithography example, the masking layer can be a resist (e.g., a photoresist), a hard mask, a metal, a dielectric (e.g., SiOₓ, Si, Al₂O₃), or the like, that is subsequently etched at selected locations to expose a portion of the tritide-forming metal. The masking layer can protect parts of the substrate that could be damaged during operation 1010.

In some aspects, masking layers can be disposed on two sides of the substrate (e.g., for a double-sided metal tritide device as in FIG. 8).

In some aspects, at operation 1008, the substrate with the tritide-forming metal is disposed in a vacuum chamber. The vacuum chamber can be a heated vacuum chamber (e.g., substrate holder can be heated). The gas in the vacuum chamber (e.g., air) can be evacuated at least in part (e.g., to increase the purity of the tritium gas used in operation 1010).

In some aspects, at operation 1010, the tritide-forming metal at a given temperature can be exposed to tritium gas at a given pressure to form metal tritide with a target thickness. The exposure to tritium gas can be performed at an elevated temperature (e.g., elevated compared to a temperature before heating is artificially applied, or elevated compared to the steady state temperature of the substrate in the vacuum chamber when no additional heat is applied). Described differently, at operation 1010, the tritide-forming metal is tritiated. Operation 1010 can be performed using one or more of the following operations. The environment in the vacuum chamber can be purified (e.g., purify with tritium). The purifying can include filling the vacuum chamber using tritium gas and/or an inert gas (i.e., one or more gases). The purifying can include evacuating and heating the vacuum chamber to degas the walls of the vacuum chamber. The inert gas can be one type of inert gas or a combination of inert gas types. The purifying can also include evacuating the vacuum chamber, at least in part, after it has been filled with the tritium gas and/or the inert gas. The evacuating of the gas and the filling of the vacuum chamber can be repeated (e.g., performed two or more times) to further increase a purity of the tritium gas.

In some aspects, the filled tritium pressure of the vacuum chamber can be, for example, about 0.001 to 50 bar, 0.001 to 30 bar, 0.1 to 30 bar, 0.1 to 10 bar, 1 to 10 bar, 0.5 to 5 bar, 0.5 to 1.0 bar, or the like. Higher pressure increases the concentration of tritium atoms available to diffuse into the tritide-forming metal. Higher pressure of tritium gas can increase the speed at which the tritide-forming metal intakes tritium atoms. However, increasing pressure depends on safety concerns and mechanical stability of the vacuum chamber, with particular consideration of the risk of leaking tritium.

In some aspects, increasing the temperature of the tritide-forming metal and/or the tritium gas can promote the chemical interaction between the tritide-forming metal and the tritium gas. In some aspects, increasing the temperature of the tritide-forming metal can increase the diffusion speed of the molecular tritium within the tritide-forming metal. The exposing of the tritide-forming metal to the tritium gas can be performed at a temperature of about 25 to 450 degrees Celsius, 50 to 450 degrees Celsius, 100 to 450 degrees Celsius, 200 to 450 degrees Celsius, 300 to 450 degrees Celsius, 400 to 450 degrees Celsius, 100 to 200 degrees Celsius, 200 to 300 degrees Celsius, or the like. The temperature can be applied via thermal conduction or radiation (e.g., a heated sample holder or infrared radiation).

In some aspects, the exposing of the tritide-forming metal to the tritium gas can be performed over an exposure time period (using the elevated temperature or not using the elevated temperature). The exposure time can be, for example, about 2 minutes to 5 hours, 30 minutes to 2 hours, 1 to 2 hours, 2 minutes to 30 minutes, 30 minutes to 1 hour, 1 hour to 2 hours, 2 hours to 5 hours, or the like. Higher temperatures can cause the tritium atoms to be energetic and diffuse faster through the lattice of the tritide-forming metal. Longer exposure times can extend the travel distance of the tritium atoms deeper into the metal layer. Temperature and exposure times can be adjusted (e.g., based on the type of metal(s) used) to achieve a target thickness of metal tritide film. That is, choosing a given temperature and/or exposure time can depend on the target thickness of the metal tritide film to be formed, which can be about 0.05 to 2.0 microns, 0.5 to 1.5 microns, 1.0 to 1.5 microns, 0.5 microns, 1.0 micron, 1.5 microns, or the like. As an example, a specific selection of exposure time, temperature, and tritium pressure can be about 10 hours at a temperature of about 250 degrees Celsius and at a tritium pressure of about 10 bars. Additional examples of tritium exposure parameters can be found in Liu et al., “Betavoltaics using scandium tritide and contact potential difference”, Applied physics letters, 92(8) (2008), which is incorporated by reference herein in its entirety.

In some aspects, the tritiation of the tritide-forming metal can be performed at selected, localized regions of the tritide-forming metal, as permitted by the openings of the masking layer applied at operation 1006. The other regions of the tritide-forming metal (covered by the masking layer) can be prevented from receiving tritium.

In some aspects, at operation 1012, the tritium gas can be evacuated from the vacuum chamber. As a safety measure, the vacuum chamber can be purified to remove even trace amounts of tritium (e.g., in order for a user to open the vacuum chamber to safely extract the substrate with the metal tritide film(s)). The purification operation can follow the filling and evacuation process as described above in reference to operation 1010, but using an inert gas and/or air. With the vacuum chamber at atmospheric pressure, the substrate with the metal tritide can be removed from the vacuum chamber.

In some aspects, at operation 1014, a protective coating is disposed on the metal tritide. The disposing of the protective coating on the metal tritide can be achieved using a suitable fabrication technique (e.g., evaporation, physical vapor deposition (PVD), sputtering, electroplating, or the like). The material of the protective coating can be, for example, a non-tritiating metal, a dielectric, a polymer (e.g., plastic), or the like. In a scenario in which the electron flux is to pass through the protective coating, the thickness and material of the protective coating can be selected so as to minimize absorption of beta particles but still provide mechanical protection for the metal tritide.

In some aspects, at operation 1016, the masking layer applied by operation 1006 can be removed. Or the masking layer can remain on for additional protection. The removal of the masking layer can be achieved using a suitable etching technique (e.g., wet etch, dry etch, chemical polish, or the like).

In some aspects, at operation 1018, the completed metal tritide can be disposed on a detector. If the metal tritide was fabricated as a large group (e.g., on a large wafer), the substrate can be diced into multiple metal tritide devices. The metal tritide devices can then be assembled with detectors to produce random signal generator units (as described in reference to FIG. 1).

The operations of FIG. 10 can be performed in any conceivable order and it is not required that all operations be performed. Moreover, the operations of FIG. 10 described above merely reflect an example of operations and are not limiting. That is, further operations are envisaged based on aspects described in reference to FIGS. 1-9.

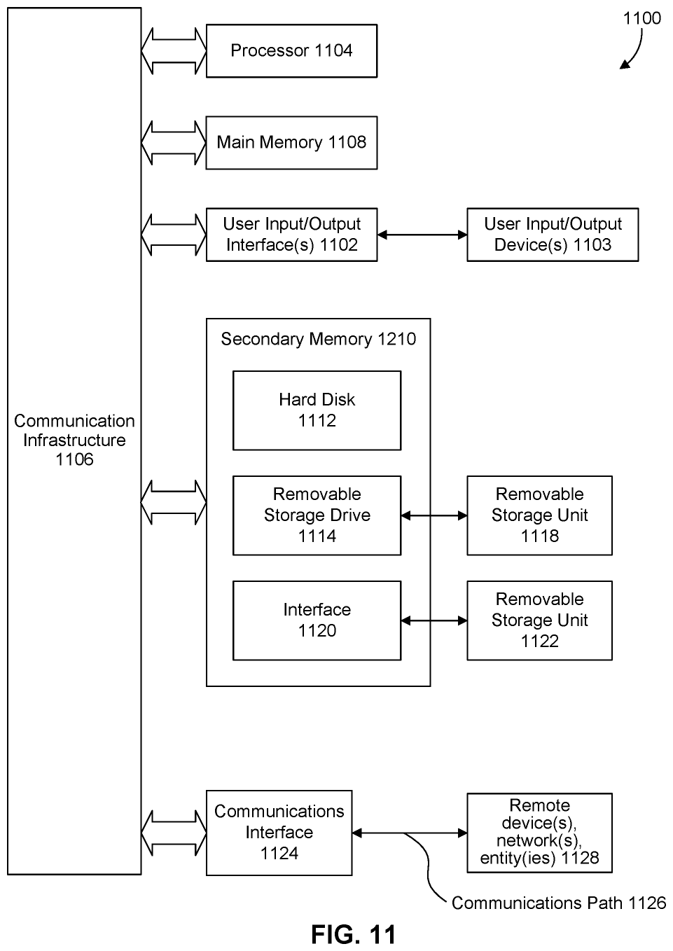

FIG. 11 shows a computer system 1100, according to some aspects. Various aspects and components therein can be implemented, for example, using computer system 1100 or any other well-known computer systems. For example, system 100 of FIG. 1 can be considered as a portion of the computer system shown in FIG. 11, with processor 102 (FIG. 1) being part of one or more processors 1104. For example, a processor chip in computer system 1100 can include processor 102 and random signal generator 106.

In some aspects, computer system 1100 can comprise one or more processors (also called central processing units, or CPUs), such as a processor 1104. Processor 1104 can be connected to a communication infrastructure or bus 1106.

In some aspects, one or more processors 1104 can each be a graphics processing unit (GPU). In some aspects, a GPU is a processor that is a specialized electronic circuit designed to process mathematically intensive applications. The GPU can have a parallel structure that is efficient for parallel processing of large blocks of data, such as mathematically intensive data common to computer graphics applications, images, videos, etc.

In some aspects, computer system 1100 can further comprise user input/output device(s) 1103, such as monitors, keyboards, pointing devices, etc., that communicate with communication infrastructure 1106 through user input/output interface(s) 1102. Computer system 1100 can further comprise a main or primary memory 1108, such as random access memory (RAM). Main memory 1108 can comprise one or more levels of cache. Main memory 1108 has stored therein control logic (i.e., computer software) and/or data.

In some aspects, computer system 1100 can further comprise one or more secondary storage devices or memory 1110. Secondary memory 1110 can comprise, for example, a hard disk drive 1112 and/or a removable storage device or drive 1114. Removable storage drive 1114 can be a floppy disk drive, a magnetic tape drive, a compact disk drive, an optical storage device, tape backup device, and/or any other storage device/drive. Removable storage drive 1114 can interact with a removable storage unit 1118. Removable storage unit 1118 can comprise a computer usable or readable storage device having stored thereon computer software (control logic) and/or data. Removable storage unit 1118 can be a floppy disk, magnetic tape, compact disk, DVD, optical storage disk, and/any other computer data storage device. Removable storage drive 1114 reads from and/or writes to removable storage unit 1118 in a well-known manner.

In some aspects, secondary memory 1110 can comprise other means, instrumentalities or other approaches for allowing computer programs and/or other instructions and/or data to be accessed by computer system 1100. Such means, instrumentalities or other approaches can comprise, for example, a removable storage unit 1122 and an interface 1120. Examples of the removable storage unit 1122 and the interface 1120 can comprise a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

In some aspects, computer system 1100 can further comprise a communication or network interface 1124. Communication interface 1124 enables computer system 1100 to communicate and interact with any combination of remote devices, remote networks, remote entities, etc. (individually and collectively referenced by reference number 1128). For example, communication interface 1124 can allow computer system 1100 to communicate with remote devices 1128 over communications path 1126, which can be wired and/or wireless, and which can comprise any combination of LANs, WANs, the Internet, etc. Control logic and/or data can be transmitted to and from computer system 1100 via communications path 1126.

In some aspects, a non-transitory, tangible apparatus or article of manufacture comprising a non-transitory, tangible computer useable or readable medium having control logic (software) stored thereon is also referred to herein as a computer program product or program storage device. This includes, but is not limited to, computer system 1100, main memory 1108, secondary memory 1110, and removable storage units 1118 and 1122, as well as tangible articles of manufacture embodying any combination of the foregoing. Such control logic, when executed by one or more data processing devices (such as computer system 1100), causes such data processing devices to operate as described herein.

Based on the teachings contained in this disclosure, it will be apparent to those skilled in the relevant art(s) how to make and use aspects of this disclosure using data processing devices, computer systems and/or computer architectures other than that shown in FIG. 11. In particular, aspects described herein can operate with software, hardware, and/or operating system implementations other than those described herein

It is to be understood that the phraseology or terminology herein is for the purpose of description and not of limitation, such that the terminology or phraseology of the present specification is to be interpreted by those skilled in relevant art(s) in light of the teachings herein.

The present disclosure has been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed. The foregoing description of specific aspects will so fully reveal the general nature of the present disclosure that others can, by applying knowledge within the skill of the art, readily modify and/or adapt for various applications such specific aspects, without undue experimentation and without departing from the general concept of the present disclosure. Therefore, such adaptations and modifications are intended to be within the meaning and range of equivalents of the disclosed aspects, based on the teaching and guidance presented herein.

It is to be understood that the Detailed Description section, and not the Summary and Abstract sections, is intended to be used to interpret the claims. The Summary and Abstract sections can set forth one or more, but not necessarily all, aspects of the present disclosure as contemplated by the inventor(s), and thus, are not intended to limit the present disclosure and the appended claims in any way. The breadth and scope of the protected subject matter should not be limited by any of the above-described aspects, but should be defined in accordance with the following claims and their equivalents.

What is claimed is:

1. A system, comprising:
a random signal generator configured to generate detection signals of radioactive decay events, the random signal generator comprising:
a detector configured to generate the detection signals based on detection of beta particles from radioactive decay of tritium, wherein the detection signals comprise randomized timing information of the radioactive decay events; and
a metal tritide device disposed at the detector and comprising the tritium, wherein the tritium is configured to undergo random radioactive decay to emit the beta particles; and
a processor configured to generate a random value based on the detection signals of the radioactive decay events.

2. A random signal generator, comprising:
a detector configured to generate detection signals of radioactive decay events based on detection of beta particles from radioactive decay of tritium, wherein the detection signals comprise randomized timing information of the radioactive decay events; and
a metal tritide device disposed at the detector and comprising the tritium, wherein the tritium is configured to undergo random radioactive decay to emit the beta particles.

3. The random signal generator of claim 2, wherein the metal tritide device is in contact with the detector.

4. The random signal generator of claim 2, wherein the detector and metal tritide device are separate at least in part by a gap.

5. The random signal generator of claim 2, further comprising an additional detector disposed at the metal tritide device and configured to:
receive additional beta particles from the metal tritide device; and
generate additional detection signals based on the additional beta particles.

6. The random signal generator of claim 5, wherein the metal tritide device is in contact with the additional detector.

7. The random signal generator of claim 5, wherein the additional detector and the metal tritide device are separate at least in part by a gap.

8. The random signal generator of claim 2, wherein the metal tritide device comprises:
a substrate; and
a metal tritide film disposed on the substrate.

9. The random signal generator of claim 8, wherein the metal tritide film has a film thickness of about 0.05 microns to 2.0 microns.

10. The random signal generator of claim 8, wherein the metal tritide device further comprises a protective coating disposed on the metal tritide film.

11. The random signal generator of claim 8, wherein:
the metal tritide film is disposed on a first side of the substrate; and
the metal tritide device further comprises an additional metal tritide film disposed on a second side of the substrate opposite the first side.

12. The random signal generator of claim 2, further comprising a scintillator disposed between the detector and the metal tritide device,
wherein the scintillator is configured to receive the beta particles from the metal tritide device and convert at least a portion of the beta particles to photons, and
wherein the detector is further configured to convert the photons to the detection signals.

13. The random signal generator of claim 2, wherein:
the metal tritide device comprises a tritiated scintillator configured to generate and absorb the beta particles to convert at least a portion of the radiated particles to photons; and
the detector is further configured to convert the photons to the detection signals.

14. The random signal generator of claim 2, further comprising one or more additional detectors and one or more additional metal tritide devices,
wherein a first random signal generator unit comprises the detector and the metal tritide device, and
wherein a second random signal generator unit comprises one of the one or more additional detectors and one of the one or more additional metal tritide devices.

15. A method, comprising:
disposing a tritide-forming metal on a substrate;
disposing the substrate with the tritide-forming metal in a vacuum chamber;
exposing the tritide-forming metal at a given temperature to tritium gas for a given exposure time to form metal tritide having a thickness that is based on the given temperature and the given exposure time;
wherein:
the disposing of the tritide-forming metal comprises disposing the tritide-forming metal on a detector comprising the substrate, or
the method further comprises disposing the metal tritide on a detector.

16. The method of claim 15, further comprising disposing a catalyst metal on the tritide-forming metal to facilitate dissociation of tritium molecules at the surface and diffusion of tritium atoms during the exposing.

17. The method of claim 15, disposing a masking layer on the tritide-forming metal.

18. The method of claim 15, wherein the given temperature is about 50 to 450 degrees Celsius.

19. The method of claim 15, wherein the given pressure is about 0.001 to 50 bar.

20. The method of claim 15, further comprising disposing a protective coating on the metal tritide.
